(19) United States
(12) Patent Application Publication
(10) Pub. No.: US 2024/0387934 A1
(43) Pub. Date: Nov. 21, 2024

(54) Battery cell module

(71) Applicant: Dr. Ing. h.c. F. Porsche Aktiengesellschaft, Stuttgart (DE)

(72) Inventors: Christopher Volkmer, Niefern-Öschelbronn (DE); Sascha Mostofi, Stuttgart (DE); Daniel Fink, Ludwigsburg (DE); Maximilian Müller, Sankt Wolfgang (DE)

(73) Assignee: Dr. Ing. h.c. F. Porsche Aktiengesellschaft, Stuttgart (DE)

(21) Appl. No.: 18/663,213

(22) Filed: May 14, 2024

(30) Foreign Application Priority Data
May 17, 2023 (DE) 10 2023 112 985.6

(51) Int. Cl. H01M 50/293; H01M 50/209; H01M 50/211; H01M 50/249; H01M 50/342

(52) U.S. Cl. CPC H01M 50/293; H01M 50/3425; H01M 50/209; H01M 50/211; H01M 50/249

(57) ABSTRACT

A battery cell module having a housing and a plurality of battery cells and separating elements. The battery cells are arranged in a stack with a separating element interposed between each pair of adjacently arranged battery cells. The stack is arranged in the housing. The battery cells each include, at one of their end regions, at least one cell connector protruding out of the respective battery cell. The battery cells of the stack are arranged in the housing such that the end regions with the cell connectors face toward an end side of the housing. At least one sealing element or a plurality of sealing elements is or are provided, which sealingly abuts or abut, firstly, the end regions of the battery cells and, secondly, the separating elements, wherein the cell connectors protrude from the at least one sealing element or sealing elements.

### CROSS-REFERENCE TO RELATED APPLICATION

This application claims priority to German Patent Application No. 10 2023 112 985.6, filed May 17, 2023, the content of such application being incorporated by reference herein in its entirety.

### FIELD OF THE INVENTION

The invention relates to a battery module, in particular to a battery module of a battery of a motor vehicle. Furthermore, the invention relates to a battery having at least one battery module, in particular as a battery of a motor vehicle.

### BACKGROUND OF THE INVENTION

Various battery modules for batteries of a motor vehicle are known from the prior art. Such battery modules serve to store electrical energy in so-called traction batteries, in order therewith to feed electric motors for powering and driving the motor vehicle.

These battery modules have a large number of battery cells arranged in a housing and electrically connected to one another. Such battery cells have the property that, in the event of damage or fault, they tend toward thermal events, which lead to chemical reactions of the constituents of the battery cells, so that very high temperatures arise in the battery cell affected and a relatively large amount of hot gas can be produced in the battery cell which has to be discharged from the battery cell and from the battery module. There exists therein the risk that the hot gas leaking from an affected battery cell comes into contact with adjacent battery cells and thermally interacts with them, and that thereby ignition of those adjacent battery cells is caused, which in turn would lead to even more hot gas leaking out of these ignited battery cells, thereby causing, in effect, a chain reaction, so that such thermal events take place in more and more battery cells, which would ultimately destroy the battery and thereby also endanger the motor vehicle.

Accordingly, the particular risk lies in the fact that thermal events take place in a constantly increasing number of battery cells, which must be avoided.

Accordingly, described herein is a battery module in which the risk that thermal events are propagated by hot gases leaking from a battery cell through ignition of further battery cells is reduced or prevented. Also described herein is a battery with at least one battery cell module.

### SUMMARY OF THE INVENTION

An example embodiment of the invention relates to a battery cell module having a housing and a plurality of battery cells and separating elements, wherein the battery cells are arranged in a stack with a separating element interposed between each pair of adjacently arranged battery cells, wherein the stack is arranged in the housing, wherein the battery cells each comprise, at one of their end regions, at least one cell connector protruding out of the respective battery cell and the battery cells of the stack are arranged in the housing such that the end regions, with the cell connectors face toward an end face of the housing, wherein at least one sealing element or a plurality of sealing elements is or are provided which sealingly abuts or abut, firstly, the end regions of the battery cells and, secondly, the separating elements, wherein the cell connectors protrude from the at least one sealing element or sealing elements. It is achieved, by this means, that the battery cells are spatially separated in a transverse direction of the stack by the separating elements, such that gases emerging from a battery cell are prevented by the separating elements from flowing to the adjacent battery cell and igniting it. The sealing element is arranged or the sealing elements are arranged at the end regions between the separating elements, said sealing element or sealing elements also having a preventative effect on a transverse flow of the gases.

Preferably, the battery cells are configured as pouch cells and/or as prismatic cells. Battery cells are known as pouch cells which have a pocket-like shape, usually having a surrounding film material and thereby a certain degree of flexibility and the ability to inflate slightly as the battery cell and its materials age. Prismatic cells are typically cuboid cells. This has the effect that the pouch cells and/or the prismatic cells have a flatter shape with approximately plane-parallel side surfaces. These two cell types therefore also have the advantage that they are readily stackable, in particular also together with the alternately arranged separating elements. A compact construction can thus be achieved.

In a further example embodiment, it is also advantageous if the separating element is configured as a flat separating element, which has a substantially two-dimensional flat construction with an extended two-dimensional extent and, compared with the two-dimensional extent, a thin third extent in a direction perpendicular to the two-dimensional extent wherein the separating element is configured compressible in the third extent. The separating element is thus a type of flat separating element or a flat partition between adjacently arranged battery cells, which is intended to prevent or restrict a gas exchange between two battery cells. In a direction perpendicular to the surface of the separating element, the respective separating element is compressible so that it can compensate for an inflating effect of the adjacent battery cells to a predefined amount.

It is also advantageous if the separating element is configured multi-ply with at least one compressible layer, in particular the separating element is formed three-ply with two substantially incompressible fire protection layers as outer layers and with a compressible intermediate layer arranged between the outer layers. As a result, the outer layers can withstand, as fire protection layers, an emergent hot gas and prevent or impede a gas flow to adjacent battery cells over a relatively long period. The compressible intermediate layer serves for adaptation when the battery cells inflate.

It is also suitable if the at least one sealing element is arranged such that it is pushed onto the end regions of the separating elements such that it both sealingly abuts the respective separating element and also, on both sides, protrudes from the respective separating element in the direction toward the adjacently arranged end region of a battery cell and sealingly abuts the end region of the adjacently arranged battery cell. As a result, in a normal case a separation of the battery cells from adjacent battery cells can be achieved by means of the at least one sealing element or by means of the sealing elements provided. If hot gas then emerges from a battery cell, this gas can flow past or break through the relevant sealing element in the region of this battery cell so that the hot gas can flow from the battery cell to an opening in the housing and can flow out of the housing, so that a flow of the gas to adjacent battery cells is prevented by the at least one sealing element. Thus, a propagation of thermal events in battery cells can be prevented.

It is particularly suitable if a sealing element is provided, which is pushed over the end regions of the separating elements and over the end regions of the battery cells, or that a plurality of sealing elements is provided, which are each pushed over an end region of a separating element and sealingly abut the end regions of the adjacently arranged battery cells. Thus, either a single overall sealing element can be used or many individual sealing elements can be used, which causes or cause the sealing of the individual battery cells.

It is particularly advantageous if the at least one sealing element has, in the region of the end regions of the battery cells, at least one outgassing point and/or at least one predetermined breaking point for the emergence of hot gases from a battery cell during a thermal event in a battery cell. By means of this outgassing point, emergent hot gas can flow out at the sealing element which seals the battery cell from which the hot gas flows, wherein the adjacent battery cells remain sealed and do not receive the emergent hot gas. The same applies to the predetermined breaking point, which breaks, for example due to pressure and/or temperature, to clear a route for the gases, wherein the adjacent battery cells still remain sealed. The at least one outgassing point and/or the at least one predetermined breaking point is associated, in each case, with one battery cell, wherein advantageously at least one outgassing point and/or at least one predetermined breaking point is associated with each battery cell, so that on emergence of hot gases, the at least one sealing element locally permits the emergence of the gases and prevents the flow toward other battery cells.

It is also particularly advantageous if the sealing element is made from a plastic material, for example a foam material, in particular a high temperature-resistant plastic or foam material. This plastic or foam material can be manufactured in a weight-optimized manner, and complex structures and constructions can also be achieved. With such a plastic or foam material, a reliable outgassing point or a reliable predetermined breaking point can also be created.

It is particularly advantageous if the housing is formed from an extruded section with at least one chamber for receiving the stack. This housing is very stable and can be reliably formed and manufactured inexpensively. It can comprise at least one degassing opening for the emergence of hot gases from the housing. On the front side, the extruded section can be closed with, for example, a cover.

An example embodiment of the invention relates to a battery, in particular for a motor vehicle, having at least one battery cell module according to aspects of the invention.

### BRIEF DESCRIPTION OF THE DRAWINGS

The invention will now be described in detail on the basis of an example embodiment and making reference to the drawings. The drawings show:

FIG. 1 shows schematically a perspective view of an example embodiment of a battery module,

FIG. 2 shows a further schematic perspective view of the example embodiment of the battery cell module,

FIG. 3 shows a further schematic representation of the example embodiment of the battery cell module, FIG. 4 shows a schematic view of an end region of a separating element with the sealing element pushed on,

FIG. 5 shows a schematic view of two end regions of a separating element each with a pushed-on sealing element, and

FIG. 6 shows a schematic view of an end region of a battery cell with a sealing element arranged thereon.

### DETAILED DESCRIPTION OF THE INVENTION

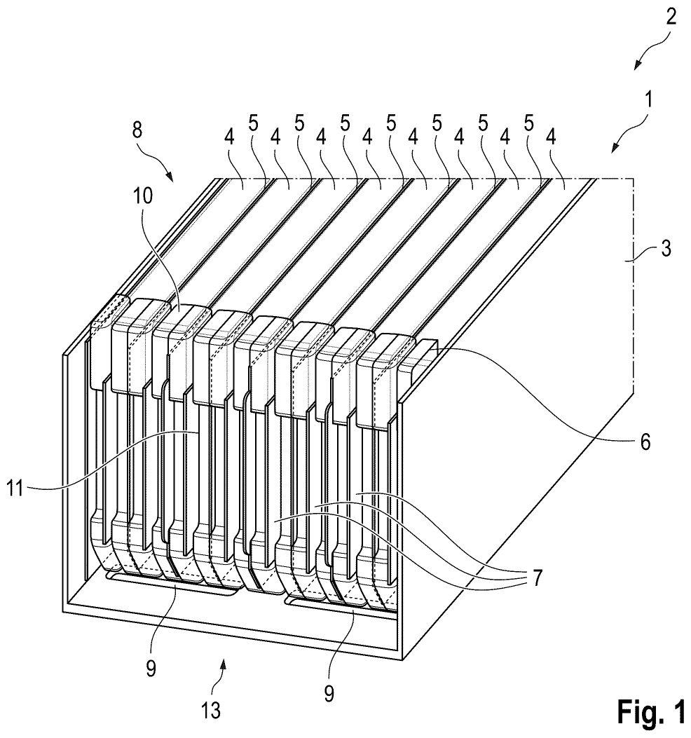

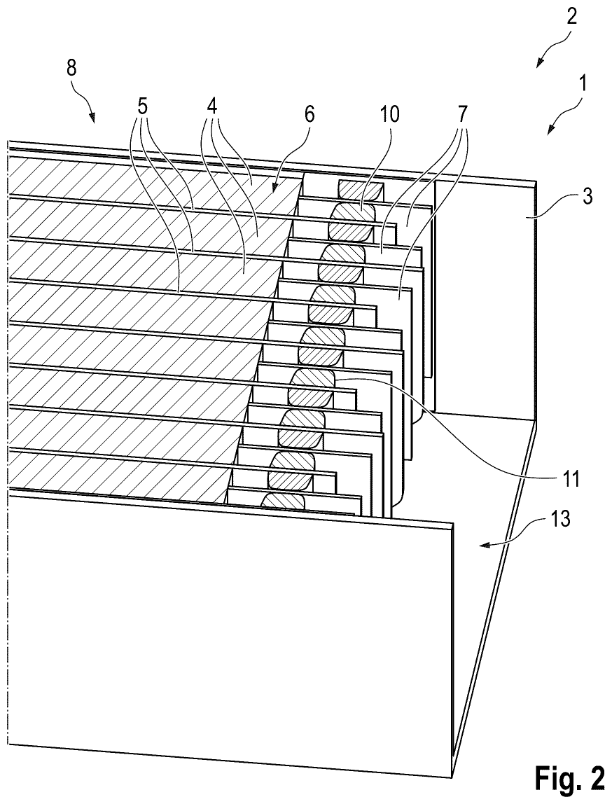

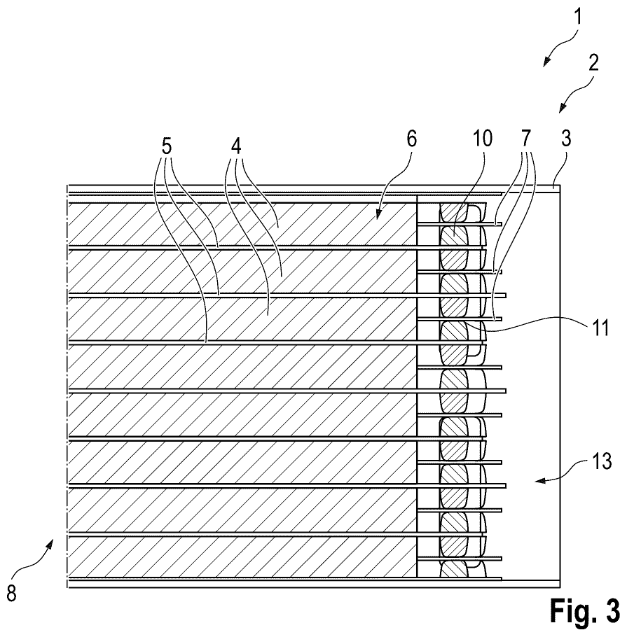

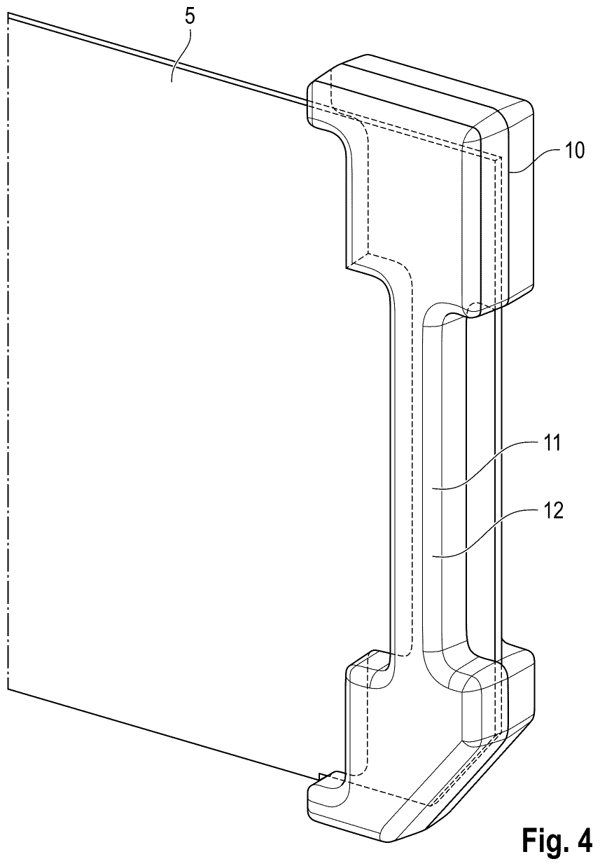

FIGS. 1 to 3 show, in respective schematic views, a battery cell module 1 of a battery 2, in particular of a motor vehicle. Therein, the battery 2 can be configured as a so-called traction battery for supplying electric motors for driving the motor vehicle. The battery 2 is preferably a high voltage battery. Alternatively, the battery 2 can also be a low voltage battery.

The battery cell module 1 shown has a housing 3. A plurality of battery cells 4 and a plurality of separating elements 5 are arranged in the housing 3.

The battery cells 4 are configured, by way of example, as so-called pouch cells. They can alternatively also be otherwise formed, for example, as prismatic cells. The pouch cells have a battery cell body, which is formed on the outside by a film, which forms a type of pocket in which the components of the battery cell 4 are arranged. The pocket of the pouch cell is substantially peripherally closed, wherein cell connectors 7 protrude from the pocket at one of the end regions 6 of the pocket for electrically connecting the battery cell 4. Advantageously, a cell connector 7 protrudes out of the pocket or two cell connectors 7 protrude out of the pocket depending on the configuration of the battery cells 4. With two cell connectors per battery cell 4, the two cell connectors can protrude from the pocket at the same end region 6 or at different end regions 6. The cell connectors 7 are also referred to as cell tabs. For example, the end regions 6 of the battery cells 4 can also be formed thinner than the battery cell body in its central region. The reason for this is that, for example, in the end region 6 substantially only the foil material of the foil of the pocket and the cell connector are arranged in this end region 6. The end region 6 can also at least partially still have the thickness of the battery cell body.

The respective separating element 5 is configured as a flat separating element 5, that is, as a substantially two-dimensional component, which has a substantially two-dimensional flat construction with an extended two-dimensional extent in one area and with a third extent that is thin in comparison with the two-dimensional extent in the area, in a direction perpendicular to the two-dimensional extent in the area. The separating element 5 is therefore very thin in the third dimension in comparison to its extent in the two-dimensional area. Very thin means at least one-tenth or less of an extension in the surface, in particular one-twentieth or less, or one-fiftieth or less.

In an example embodiment, the separating element 5 can be a thin metal or plastic strip, for example a foam element strip, which is formed in one piece. A coating, etc., could also be provided. Preferably, the separating element 5 is made of a fire protection material.

In a further example embodiment, the separating element 5 is configured to be compressible in the third extent, that is, perpendicular to the flat extent. This causes the separating elements 5 to be able to be compressed somewhat when the battery cells 4 are inflated, to compensate for the inflation of the battery cells 4 so that damage does not occur immediately, in particular to the separating elements 5, the battery cells 4 and/or the housing 3.

A preferred example embodiment can thus provide that the separating element 5 is formed in multiple layers with at least one compressible layer. This compressible layer thereby brings about the compressibility of the separating element 5. For example, the separating element 5 is formed in three layers with two substantially incompressible fire protection layers as outer layers and with a compressible intermediate layer arranged between the outer layers. It is thereby achieved that the separating element 5 cannot be quickly damaged by the emergent hot gases, and the separating element 5 is nevertheless compressible. Alternatively, the separating element 5 can also be formed in two layers with a substantially incompressible fire protection layer as an outer layer and with a further compressible second layer.

For example, mica can be used for the separating element 5 or for the fire protection layers of the separating element 5. Preferably, the compressible intermediate layer or the second layer can be formed from a foam material, for example a PU foam or a silicone foam. Alternatively, the separating element 5 itself can be made, for example single ply, from a foam material, for example a PU foam or a silicone foam.

According to FIGS. 1 to 3, the separating elements 5 are dimensioned such that, in the flat construction and extent, they extend beyond the extent of the battery cell 4, in particular beyond the extent of the battery cell body. Only the cell connectors 7 protrude forwardly at the end face between the separating elements 5.

On closer examination of FIGS. 1 to 3, the separating elements 5 are configured to be alternately shorter or longer, for example at the end face, so that the cell connectors 7 protrude forwardly beyond the shorter separating elements 5 or terminate forwardly approximately flush with the longer separating elements 5.

As can be seen from FIGS. 1 to 3, the battery cells 4 are arranged with interposition of a separating element 5 between each pair of adjacently arranged battery cells 4 in a stack 8, the stack 8 being arranged in the housing 3.

The housing 3 is preferably formed from an extruded section, also called an extrusion profile, which forms at least one chamber 13, into which or into each of which at least one stack 8 is inserted. The housing 3 can therein be closed at the end face by a housing cover, although this is not shown. It can also be seen in FIG. 1 that at least one opening 9 is provided or openings 9 are provided in the housing 3, which serve to discharge the gas or serve to allow the hot gas to be quickly guided out of the housing 3 after it emerges from the battery cell 4. The opening 9 is, or the openings 9 are, arranged adjacent to the cell connectors 7 and/or the end regions 6 of the battery cells 4.

The housing 3 can alternatively also form, for example, two chambers 13 for two stacks 8 or a common chamber 13 for inserting a plurality of stacks 8.

Since, as described above, the battery cells 4 each comprise at least one cell connector 7 protruding from the respective battery cell 4 at one of its end regions 6, the battery cells 4 of the stack 8 are arranged in the housing 3 such that the end regions 6 with the cell connectors 7 face toward an end face of the housing 3. Thus, the cell connectors 7 can easily be electrically contacted.

Furthermore, at least one sealing element 10 or a plurality of sealing elements 10 is provided, wherein the sealing element 10 or the sealing elements 10 sealingly abuts or abut firstly the end regions 6 of the battery cells 4 and secondly the separating elements 5, wherein the cell connectors 7 protrude from the at least one sealing element 10 or from the sealing elements 10. The sealing elements 10 thus seal each of the battery cells 4, at the front, between the separating elements 5 and the cell connectors 7 protrude further forwardly out of the sealing elements 10 or between the sealing elements 10, in order to be able to contact them. The cell connectors 7 protrude beyond the sealing element 10 or the sealing elements 10 provided.

According to FIGS. 1 to 3, the at least one sealing element 10 is arranged such that it is pushed onto the end regions of the separating elements 5 so that it both sealingly abuts the respective separating element 5 and on both sides also protrudes from the respective separating element 5 in the direction toward the adjacently arranged end region 6 of a battery cell 4 and sealingly abuts the end region 6 of the adjacently arranged battery cell 4. A sealed region is thereby generated between the separating element 5 and the end region 6 of the battery cell 4.

A sealing element 10 can therein be provided, which is pushed over the end regions of the separating elements 5 and over the end regions 6 of the battery cells 4. Alternatively, it can also be constructed such that a plurality of sealing elements 10 is provided, with many sealing elements 10, which are each pushed over an end region of a separating element 5 and sealingly abut the end regions 6 of the adjacently arranged battery cells 4.

In principle, the sealing element 10 can sealingly abut the end region 6 of the battery cell 4, that is it can sealingly abut the thinner formed end region of the pocket, the cell connector 7 and/or the end region 6 of the battery cell body.

Alternatively, it can also be constructed such that a plurality of sealing elements 10 is provided, with many sealing elements 10, which are each pushed over an end region 6 of a battery cell 4 and sealingly abut the end regions of the adjacently arranged separating elements 5.

If a thermal event occurs in a battery cell 4, generating hot gas, the battery cell 4 bursts in the region of the cell connectors 7 and the gas exits forwardly toward the at least one sealing element 10. In the region of the end regions 6 of the battery cells, the at least one sealing element 10 has at least one outgassing point 11 and/or at least one predetermined breaking point for the emergence of hot gases from a battery cell 4 during a thermal event in a battery cell 4.

The sealing element 10 or each sealing element 10 can be arranged fastened on the respective separating element 5, in particular also on a fire protection layer of the separating element 5, for example, by means of a materially bonded and/or friction-locking and/or positive-locking connection.

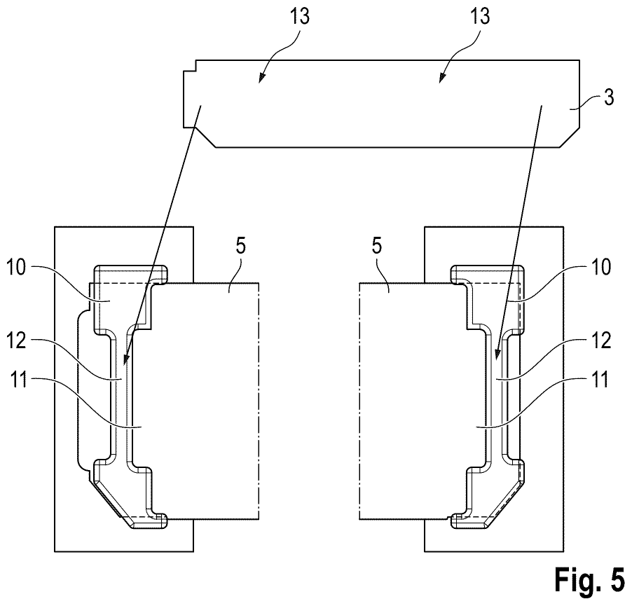

FIGS. 4 to 6 each show a separating element 5 with a sealing element 10, two separating elements 5, each with a sealing element 10 and a battery cell 4 each with an end region 6 and a sealing element 10.

It can be seen that each sealing element 10 has a vertically arranged web 12 that is reduced in its extent, which serves as the outgassing point 11 and/or as the predetermined breaking point. At this site of the web 12, a site as a geometric reduction, the hot gas can either push away or damage the sealing element 10 to create a passageway for the escape of the hot gas. At the upper and lower regions of the sealing element 10, it is constructed wider and more stable so that the sealing element 10 is held at these sites in the housing 3, even if the web 12 is pushed away or damaged.

It can also be seen from FIGS. 4 to 6 that the respective sealing element 10 is constructed such that it can be fitted at the top and bottom in the housing 3 so that it also sealingly abuts the housing 3 there.

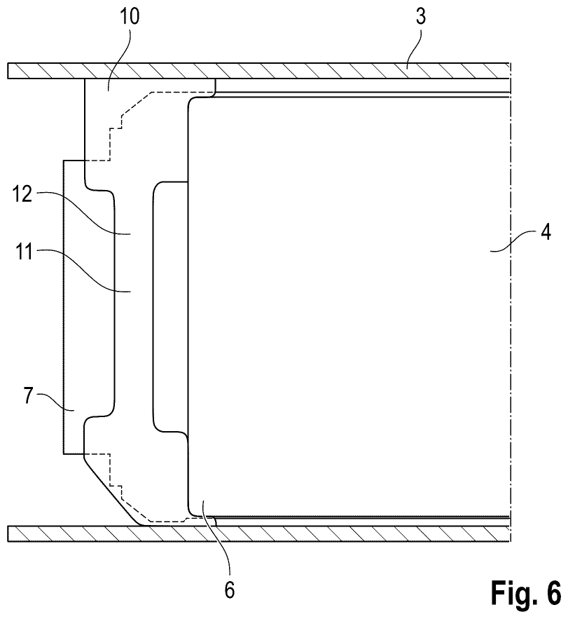

It can also be seen in FIG. 4 that the sealing element 10 receives the end region of the separating element 5 in a type of receptacle or slot and the sealing element 10 extends from the separating element 5 toward the side and there forms a planar abutment surface for the sealing abutment of the end region 6 of the adjacently arranged battery cell 4, as can be seen in FIG. 6.

Particularly preferably, the sealing element 10 is formed from a plastic material. It can be formed from a foam material, a rubber material, etc., in particular from a high temperature-resistant plastic or foam material.

### LIST OF REFERENCE SIGNS

1 Battery cell module
2 Battery
3 Housing
4 Battery cell
5 Separating element
6 End region
7 Cell connector
8 Stack
9 Opening
10 Sealing element
11 Outgassing point
12 Web
13 Chamber

What is claimed is:

1. A battery cell module comprising:
a housing; and
a plurality of battery cells and separating elements arranged in the housing, wherein the battery cells are arranged in a stack with one of the separating elements interposed between each pair of adjacently arranged battery cells,
wherein the stack is arranged in the housing,
wherein the battery cells each comprise at least one cell connector protruding out of the respective battery cell at one end region of the respective battery cell,
wherein the battery cells of the stack are arranged in the housing such that the end regions with the cell connectors face toward an end face of the housing,
wherein the battery cell module further comprises at least one sealing element or a plurality of sealing elements, which sealingly abuts or abut, firstly, the end regions of the battery cells and, secondly, the separating elements, and
wherein the cell connectors protrude from the at least one sealing element or sealing elements.

2. The battery cell module according to claim 1, wherein the battery cells are pouch cells or prismatic cells.

3. The battery cell module according to claim 1, wherein each separating element is a flat separating element which has a substantially two-dimensional flat construction with an extended two-dimensional extent and, compared with the two-dimensional extent, a thin third extent in a direction perpendicular to the two-dimensional extent, wherein the separating element is configured compressible in the third extent.

4. The battery cell module according to claim 3, wherein the separating element is three-ply structure with two substantially incompressible fire protection layers as outer layers and a compressible intermediate layer arranged between the outer layers.

5. The battery cell module according to claim 1, wherein the at least one sealing element is arranged to be pushed onto end regions of the separating elements, such that the sealing element both sealingly abuts the respective separating element and, on both sides, also protrudes from the respective separating element in a direction toward the adjacently arranged end region of a battery cell and sealingly abuts the end region of the adjacently arranged battery cell.

6. The battery cell module according to claim 5, wherein either (i) the sealing element is arranged to be pushed over the end regions of the separating elements and over the end regions of the battery cells, or (ii) a plurality of the sealing elements are each arranged to be pushed over an end region of a separating element and sealing abut the end regions of the adjacently arranged battery cells.

7. The battery cell module according to claim 1, wherein the at least one sealing element has, in a region of the end regions of the battery cells, at least one outgassing point and/or at least one predetermined breaking point for emergence of hot gases from one of the battery cells during a thermal event in a battery cell.

8. The battery cell module according to claim 1, wherein the sealing element comprises a plastic material, a foam material, a high temperature-resistant plastic material or a high temperature-resistant foam material.

9. The battery cell module according to claim 1, wherein the housing is an extruded section with at least one chamber for receiving the stack.

10. A battery for a motor vehicle comprising the battery cell module according to claim 1.

11. A vehicle comprising the battery of claim 10.
